(19) United States
(12) Patent Application Publication
(10) Pub. No.: US 2026/0320625 A1
(43) Pub. Date: Oct. 15, 2026

(54) ACCESS CONTROL AND DELEGATION SYSTEM AND METHOD FOR PRODUCTS OR SERVICES PROVIDED TO CUSTOMERS BY A BUSINESS

(71) Applicant: Dell Products L.P., Round Rock, TX (US)

(72) Inventors: Wai Yim, Merrimack, NH (US); Matthew Robert Hoffmann, Pflugerville, TX (US)

(73) Assignee: Dell Products L.P., Round Rock, TX (US)

(21) Appl. No.: 19/179,150

(22) Filed: Apr. 15, 2025

(51) Int. Cl. G06Q 30/015

(52) U.S. Cl. CPC G06Q 30/015

(57) ABSTRACT

Systems and methods for managing the relationships of a business and one or more partners of the business used to provide products and services to a customer are disclosed. According to one embodiment, an Information Handling System (IHS) may include executable instructions to generate an object model comprising a business object representing a business that provides one or more assets represented by one or more asset objects to a customer represented by a customer object of the business. Using a contract object of the object model, the instructions may identify what level of services are to be provided by each asset for the customer, and provide each of the services to the customer according to the identified level for the customer.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes.

Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of “Infrastructure as a Service” (IaaS), “Platform as a Service” (PaaS), and/or “Software as a Service” (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

### SUMMARY

Systems and methods for managing the relationships of a business and one or more partners of the business used to provide products and services to a customer are disclosed. According to one embodiment, an Information Handling System (IHS) may include executable instructions to generate an object model comprising a business object representing a business that provides one or more assets represented by one or more asset objects to a customer represented by a customer object of the business. Using a contract object of the object model, the instructions may identify what level of services are to be provided by each asset for the customer, and provide each of the services to the customer according to the identified level for the customer.

According to another embodiment, an access control and delegation method includes the step of generating an object model comprising a business object representing a business that provides one or more assets represented by one or more asset objects to a customer represented by a customer object of the business, using a contract object of the object model, identifying what level of services are to be provided by each asset for the customer, and providing each of the services to the customer according to the identified level for the customer.

According to yet another embodiment, a non-transitory memory storage device with program instructions stored thereon that, upon execution by an Information Handling System (IHS), cause the IHS to generate an object model comprising a business object representing a business that provides one or more assets represented by one or more asset objects to a customer represented by a customer object of the business, using a contract object of the object model, identify what level of services are to be provided by each asset for the customer, and provide each of the services to the customer according to the identified level for the customer.

### RIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement embodiments of the present disclosure.

FIG. 2 illustrates an example access control and delegation system that may be used to manage the relationships of a business and one or more partners of the business used to provide products and services to a customer according to one embodiment of the present disclosure.

FIG. 3 illustrates an example customer to primary business and partner relationship model that may be used by the access control and delegation service according to one embodiment of the present disclosure.

FIG. 4 illustrates an example core hierarchy building block that may be used by the access control and delegation service according to one embodiment of the present disclosure.

FIG. 5 illustrates an example virtual customer building block model that may be used by the access control and delegation service according to one embodiment of the present disclosure.

FIG. 6 illustrates an example object model that may be generated for cases having a single customer and a single partner according to one embodiment of the present disclosure.

FIG. 7 illustrates another example object model that may be generated for cases having a single customer and multiple partners according to one embodiment of the present disclosure.

FIG. 8 illustrates another example object model that may be generated for cases having a multiple customers and a single partner according to one embodiment of the present disclosure.

FIG. 9 illustrates yet another example object model that may be generated for cases having a multiple customers and multiple partners according to one embodiment of the present disclosure.

FIG. 10 illustrates an example Access Control and Delegation method that may be used to manage how products and/or services are provided to a customer according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

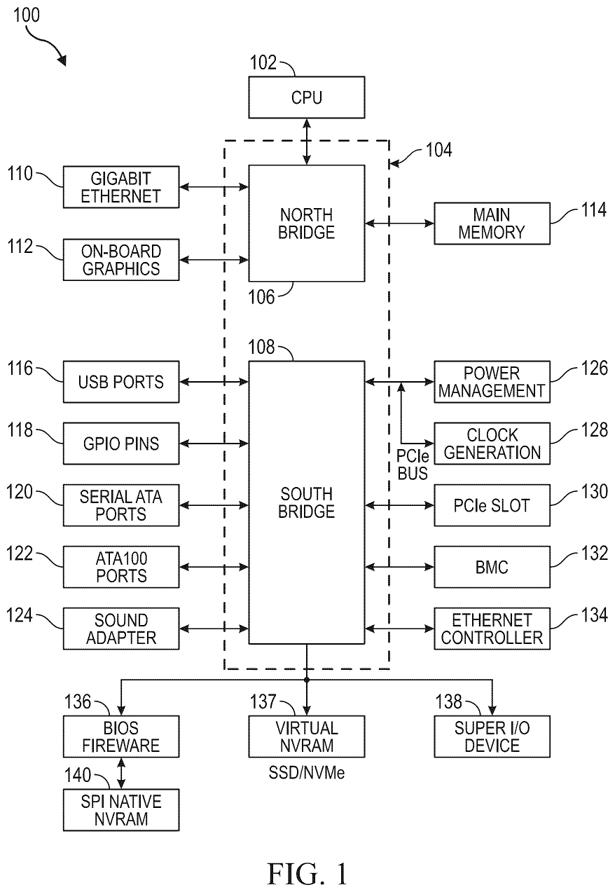

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Modern businesses often have complex customer and partner relationships as ecosystems are required to address today's customer needs well.

Authentication, authorization, and access control policies of rights and privileges of products and services in such an ecosystem can present significant challenges when it comes to security, scalability, and accountability. Furthermore, each party in the ecosystem should have autonomy in how they assign or delegate rights and privileges within their organization. To address these challenges, a comprehensive system may be useful to express these relationships, while allowing each party in the ecosystem to perform their roles and responsibilities in a secure, scalable, and accountable manner. As will be described in detail herein below, embodiments of the present disclosure provide an access control and delegation system and method that expresses the relationships of a business and one or more partners of the business used to provide products and services to a customer.

FIG. 1 shows an example of an IHS 100 that may be configured to implement embodiments of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100.

Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, and the like. Additionally or alternatively, BMC 132 may include one or more firmware volumes, each volume having one or more firmware files used by the BIOS′ firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The IDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

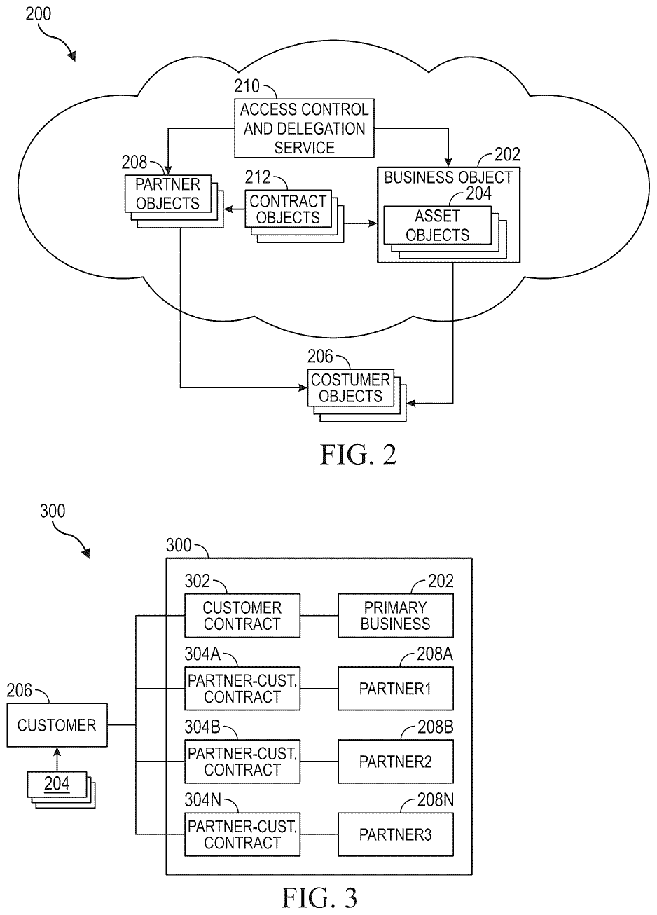

FIG. 2 illustrates an example access control and delegation system 200 that may be used to manage the relationships of a business and one or more partners of the business used to provides products and services to a customer according to one embodiment of the present disclosure. The access control and delegation system 200 generally involves a business object 202 representing a business that provides one or more assets represented by asset objects 204 to customers represented by customer objects 206 of the business. The access control and delegation system 200 may also involve one or more partner objects 208 representing partners that provides services associated with the assets, and one or more contract objects 212 representing contracts identifying what level of services are to be provided by each asset for each customer.

According to embodiments of the present disclosure, the access control and delegation system 200 includes an access control and delegation service 210 that uses the objects 202, 204, 206, and 208 to manage how the assets of the business may be used by each customer as will be explained in detail herein below.

The assets may include any product or service that is provided to its customers by the business. For example, the assets may include multiple computing hardware devices, such as servers, workstations, laptop computers, and the like that may be provided by a vendor to its customers. As another example, the assets may include cloud computing services, such as those that may be provided, for example, by an Infrastructure as a Service” (IaaS), “Platform as a Service” (PaaS), and/or “Software as a Service” (SaaS), cloud computing resources (e.g., storage, network, servers, and/or compute servers), and the like. The partners may include any entity that provides support for the assets used by each customer. Examples of partners may include maintenance organizations that maintain the assets for the customer, accounting management of the assets, and the like.

Embodiments of the present disclosure may be built on several customer data concepts, such as digital representation of customers and organizations, product and offers representation, virtual customer, and tenant boundaries. With regard to digital representations of customers and organizations, in the modern digital world, customers and their companies or organizations are often represented abstractly as a hierarchy of objects such as organizational profiles, email domains, physical addresses of company locations, virtual presences on the internet or cloud, person profile of employees, and the like. These customer hierarchical abstractions, called core hierarchies, can also contain legal information such as trade compliance, government mandates, geopolitical implication, and the like, for the business to operate properly according to applicable laws.

With product and offers representation, depending on the business, and products and services being offered, there are additional objects attached to the core hierarchy to represent the relationship between the business and its customers. Such objects can be sales and service contracts, asset/service instances for status and management, financial operations such as subscriptions, and the like. In this class of objects, there is often an object that represents a resource and other objects that describes additional characteristics of the resource. An example of a resource is an asset 204 that a customer purchases with the entitlements and service contracts as additional objects that describe what the customer can do and what the business's obligation is for service of the asset.

With virtual customers, while the core customer hierarchy represents legal aspects of the relationship between the business and the customer, virtual customer overlays the core hierarchy to provide flexibility to how customers want to define their organizational structure as well as application specific organizational structure and object model. Virtual customers also provide the customers with a mechanism to define resource grouping and administration of access control. With tenant boundaries, in the context of this disclosure, a tenant boundary is essentially the visibility of objects and access control within a core customer hierarchy. For instance, tenant boundary can be implemented as a virtual customer overlaying a core customer hierarchy.

The life cycle of resources along with their access control can be complex given the diversity of operating expenses (OpEx), capital expenses (CapEx), and mixed consumption models. Couple this diversity with the nature of ecosystems where a collection of the business and its partners provides services to customers.

Embodiments of the present disclosure defines each party in the ecosystem as a separate core hierarchy tree including the customer and the partner businesses. The roles and responsibilities of each party in this ecosystem depend on the business arrangement reflected by legal agreements. Each party uses contract nodes to link to resources. These contract nodes define the legal roles and responsibilities, and entitlements of that party to the resource. Each party in the ecosystem can leverage the virtual customer construct to independently define administration and delegation of access and control of groups of resources in the form a tenant boundary.

FIG. 3 illustrates an example customer to primary business and partner relationship model 300 that may be used by the access control and delegation service 210 according to one embodiment of the present disclosure. The primary business and partner relationship model 300 may be expressed from the perspective of the primary business 202 and its relationship with the customer 206 in an ecosystem of partner companies. As shown, the customer 206 is related to the primary business 202 by a customer contract 302. The customer 206 may also be related to one or more partners 208a-n (collectively 208) via partner/customer contracts 304a-n (collectively 304). Direct relationships between the customer and partners 208 are not tracked by the primary business 202 as the roles and responsibilities of such relationships do not concern the primary business 202.

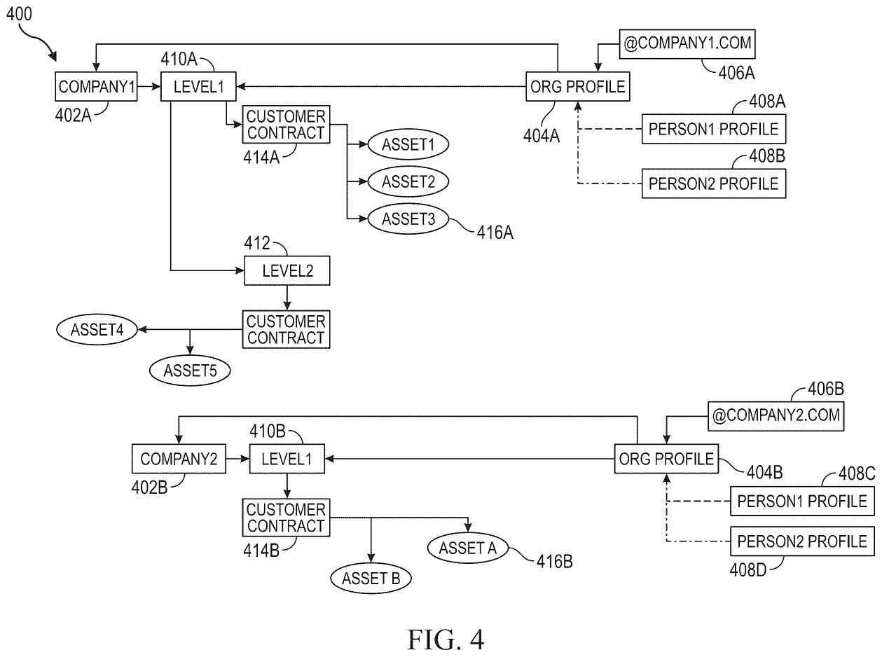

FIG. 4 illustrates an example core hierarchy building block 400 that may be used by the access control and delegation service 210 according to one embodiment of the present disclosure. In the particular core hierarchy building block 400 shown, the customer is embodied as a company1 402a with multiple employees. Each customer of the primary business 202 may be represented by a core hierarchy of objects. The top node, root in the hierarchy is the object company1 402a. An organizational profile 404a is attached to the root of the hierarchy that describes the facts about company1 402a (e.g., the customer). Each organization profile 404a has at least one email domain 406a. While company1 402a is shown with only one email domain, in other embodiments, it is possible for a customer to have more than one email domain. Personnel or employees of company1 402a may be represented by person profiles 408a-b that may include personal information, such as contact email address, phone number, roles, and the like. Person profiles 408a-b are onboarded to the organizational profile 404a to reflect the relationship of the person to the organization.

Below the top node, namely company1 402a, the core hierarchy of a customer may be configured with different levels. There can be multiple nodes 410 at any given level such as different locations of a company. Different levels reflect organizational structures such as node 412 that represents a subsidiary of its parent company1 402a. Customer contracts 414a describe the legal agreement between the primary business and the customer. For example, a customer contract may describe a set of assets 416a sold to a customer and what the terms of support are. There are many types of contracts to flexibly define different types of legal agreements, such as a subscription.

A different customer is represented by a separate core hierarchy 402b with a different organization profile 404b, person profiles 408c-d, level 410b and location structure, customer contracts 416b, email domain 406b, and the like.

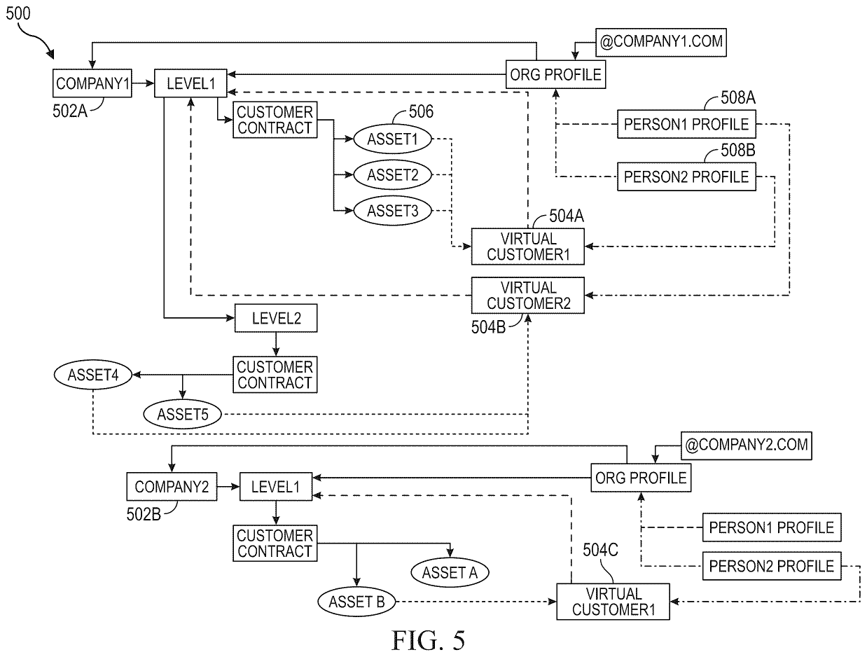

FIG. 5 illustrates an example virtual customer building block model 500 that may be used by the access control and delegation service 210 according to one embodiment of the present disclosure. The virtual customer building block model 500 includes a first company object 502a that is established with multiple virtual customer objects 504a-b each representing a tenant boundary established for a subset of users within the first company represented by the first company object 502a. The virtual customer building block model 500 also includes a second company object 502b that is established with a virtual customer object 504c each representing a tenant boundary established for a subset of users within the first company represented by the first company object 502a.

In general, each tenant boundary 504a-c is a construct defining how the users of the customer are organized. For example, the tenant boundary 504a-c may be based on a location where each user is at, what department (e.g., accounting, research and development, management, shipping, etc.) they are in, or other organizational factors. While the core hierarchy as described above with reference to FIG. 4 provides the backbone for integrity, control, and governance, a virtual customer construct provides flexibility on how the customer wants to define their tenant boundaries when consuming products and services from the primary business. As an example, the first customer company object 502a may define different tenants as virtual customer objects 504a-b each having different asset objects 506, and different user objects 508a-b defining specific roles, such as an administrator of the tenant. This construct separates the details such as locations, legal contracts, and the like from how the customer wants to organize resources and the administration of those resources.

Leveraging the core hierarchy and virtual customer concepts as building blocks, embodiments of the present disclosure may provide secure flexible access control and accountability, even in complex ecosystems of businesses and partnerships. As will be described in detail below with reference to FIGS. 4-7, the scalability of the access control and delegation system 200 accommodates diverse roles and responsibilities of increasingly complex relationships among a primary business, its customers, and the partners of the primary business that provide different services to the end customers. In these examples, the customer and each partner are represented by a core hierarchy.

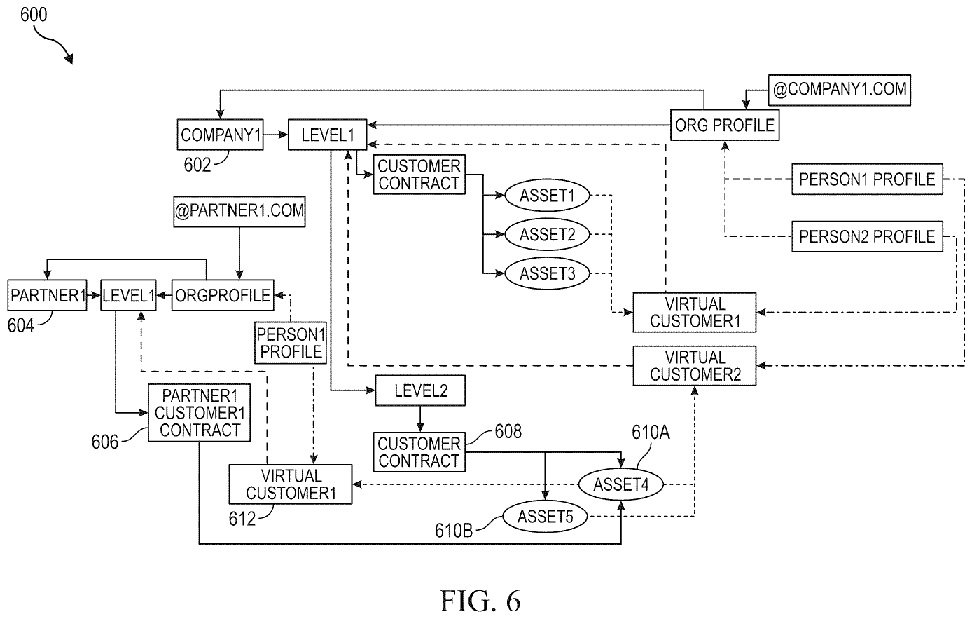

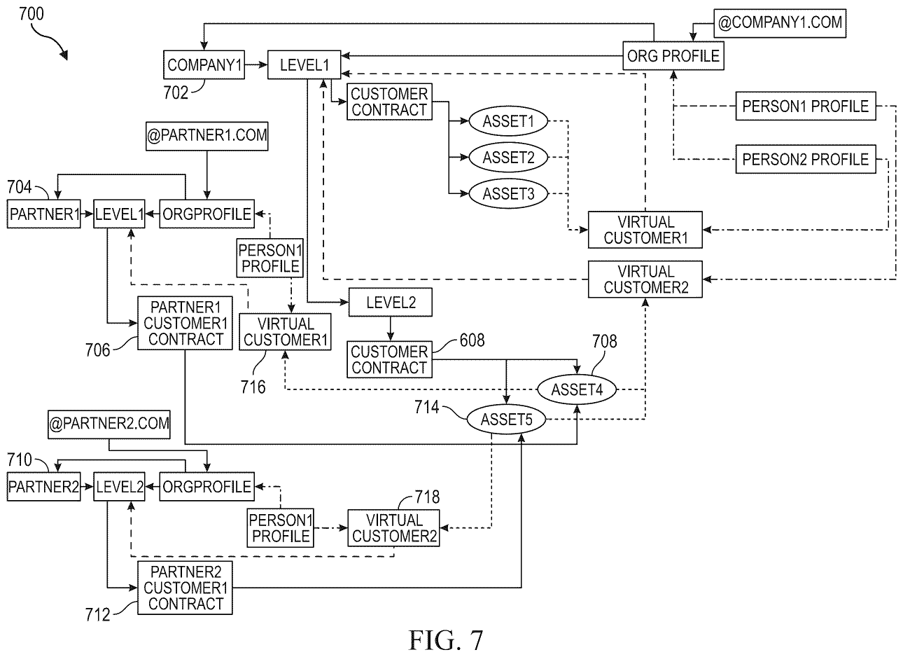

FIG. 6 illustrates an example object model 600 that may be generated for cases having a single customer and a single partner according to one embodiment of the present disclosure. In this particular example embodiment, company1 object 602 of the primary business has a single partner represented by partner object, namely Partner1 object 604, providing a service defined by a contract represented by contract object 606 that defines the roles and responsibilities of the partner. Note that the contract object 608 associated with a contract between the customer and the primary business applies to two assets represented by Asset4 object 610a and Asset5 object 610b, while the contract between the customer and the partner only applies to one asset, namely Asset4 object 610a. This example demonstrates the flexibility of the solution in defining relationships among various parties in the ecosystem.

The partner can then leverage the virtual customer object 612 to define tenant boundaries, and roles and responsibilities within the partner organization to delegate access and control using the partner's own IdP (Identity Provider) for authentication and authorization. The extent of the privileges the partner can delegate within its organization is bound by the contract associated with the contract object 606 between the customer and the single partner.

FIG. 7 illustrates another example object model 700 that may be generated for cases having a single customer and multiple partners according to one embodiment of the present disclosure. In this particular example embodiment, company1 object 702 of the primary business has a single partner represented by multiple partner objects, namely Partner1 object 704 and Partner2 object 710.

Often, a customer of the primary business will have relationships with multiple partners of the primary business. To demonstrate the use cases and how this solution scales, the customer Company1 702 of the primary business has multiple partner relationships. Partner1 object 704 associated with a first partner has a contract represented by contract object 706 defining the roles and responsibilities of Partner1 to the end customer asset(s), namely the Asset4 object 708. The Partner2 object 710 associated with a second partner has a separate contract object 712 associated with a contract defining a different set of roles and responsibilities to different end customer asset(s) represented by the Asset5 object 714. Each partner can define their own tenant boundaries, which may be represented by Virtual Customer1 object 716 and Virtual Customer2 object 718, within their organization and delegate access and control of the assets. This approach may allow each of the parties in the ecosystem including the customer represented by customer company1 702 and each of the partners represented by 704, 710 to define their own tenant boundaries independent of each other.

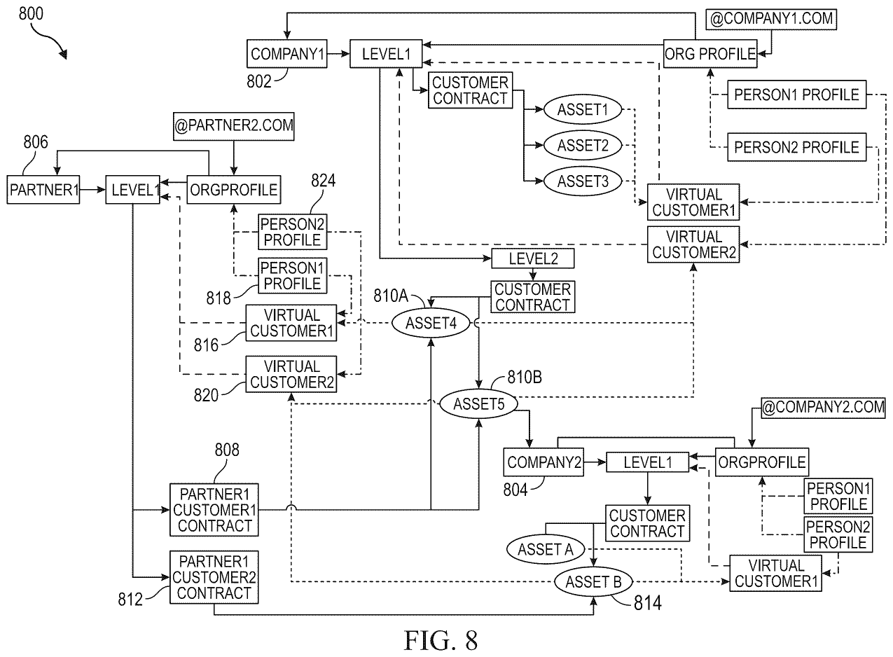

FIG. 8 illustrates another example object model 800 that may be generated for cases having a multiple customers and a single partner according to one embodiment of the present disclosure. In this particular example embodiment, company1 object 802 representing a first customer, and Company2 object 804 representing a second customer of the primary business has a single partner represented by a single partner object, namely Partner1 object 806 representing a single partner.

While a customer may receive services from multiple partners, each partner may provide services to multiple customers. In this example embodiment, Partner1 object 806 associated with a single partner has separate contracts with a first company represented by Company1 object 802 and a second company represented by Company2 object 804. A first contract represented by the Partner1-Customer1 contract 808 covers multiple assets, namely assets represented by Asset4 810a and Asset5 810b. A second contract represented by a Partner1-Customer2 contract object 812 covers one asset represented by Asset B 814. Partner1 can define multiple tenant boundaries with different business rules to manage these different customers and assets.

As an example, the business rule associated with the Tenant boundary Virtual Customer1 816 only allows assets from a single end customer, Asset4 810a from Company1. Person1 object 818 is assigned as an administrator with roles and responsibilities defined in the Partner1-Customer1 contract object 808. Similarly, the business rule for Tenant boundary Virtual Customer2 820 allows assets from different end customers, namely Asset5 810b from Company1 and Asset B 814 from Company2, to be aggregated for easier, more efficient management from the partner's perspective. A different class of personnel, namely the Person2 object 824, may be assigned to manage this different type of tenant boundary. This example demonstrates the capability of combining partner-customer contracts with partner tenant boundaries to provide flexibility and precision on how roles and responsibilities defined in the contract can be assigned and delegated within the partner organization.

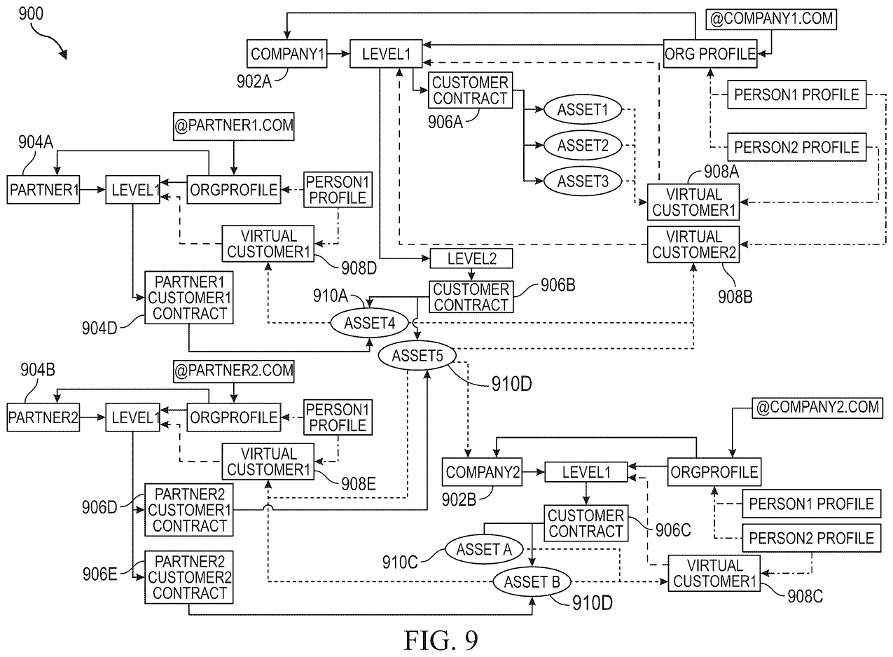

FIG. 9 illustrates yet another example object model 900 that may be generated for cases having a multiple customers and multiple partners according to one embodiment of the present disclosure. In this particular example embodiment, company1 object 902a representing a first customer, and Company2 object 902b representing a second customer of the primary business has multiple partners represented by partner objects 904a-b.

In an ecosystem with multiple customers represented by customer objects 902a-b and multiple primary businesses and partners represented by partner objects 904a-b, relationships between parties may be expressed in legal contracts represented by contract objects 906a-e that define many attributes of the relationship. In the context of this disclosure, the access control roles and responsibilities are the key elements and the focus of such contracts. Within the bounds of the contracts, each party has the autonomy to design their own tenant boundaries 908a-e used to assign and delegate access control of resources represented by asset objects 910a-d.

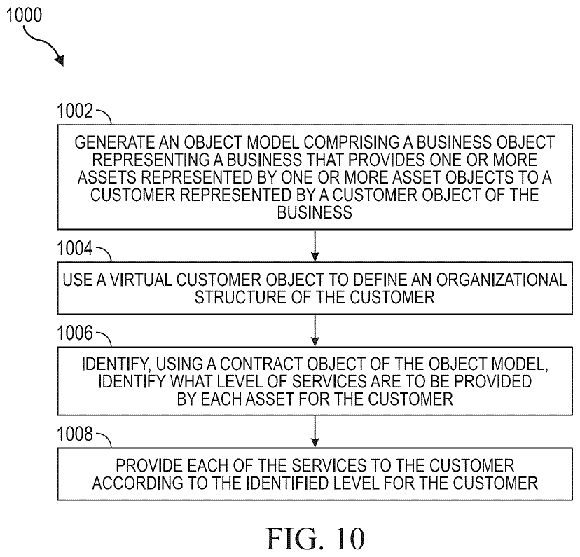

FIG. 10 illustrates an example Access Control and Delegation method 1000 that may be used to manage how products and/or services are provided to a customer according to one embodiment of the present disclosure. Additionally or alternatively, the Access Control and Delegation method 1000 may be performed by the access control and delegation system 200 as shown above with reference to FIG. 2. Also, the Access Control and Delegation method 1000 may be performed continually as the assets of the primary business are consumed by its customers.

Initially at step 1002, the Access Control and Delegation method 1000 may generate an object model that includes a business object representing a business that provides one or more assets represented by one or more asset objects to a customer represented by a customer object of the business. In one embodiment, the Access Control and Delegation method 1000 may generate the object model with partner objects representing partners that provides services associated with the assets. For example, the Access Control and Delegation method 1000 may use another contract model associated with the partner that is separate and distinct from the contract object associated with the business. As another example, the assets may include a computing hardware device and/or a cloud computing service.

At step 1004, the Access Control and Delegation method 1000 may use a virtual customer object to define an organizational structure of the customer. For example, the virtual customer object may be defined as a tenant boundary that comprises the visibility of objects and access control within a customer hierarchy of the customer. In one embodiment, the Access Control and Delegation method 1000 may arrange the customer as multiple objects in a hierarchy comprising multiple groups of people that consume the assets, wherein the customer comprises a company. For example, the Access Control and Delegation method 1000 may generate the object model with one or more email object associated with a domain of the company.

At step 1006, the Access Control and Delegation method 1000 may identify, using a contract object of the object model, identify what level of services are to be provided by each asset for the customer, and at step 1008, it may provide each of the services to the customer according to the identified level for the customer.

The Access Control and Delegation method 1000 may be continually performed as the customer is using the assets provided by the primary business. Nevertheless, when use of the method 1000 is no longer needed or desired, the process ends.

Although FIG. 10 describes one embodiment of how products and/or services are provided to a customer, the features of the process may be embodied in other specific forms without deviating from the spirit and scope of the present disclosure. For example, the process may perform additional, fewer, or different operations than those described in the present examples. For another example, the process may be performed in a sequence of steps different from that described above. For yet another example, the process may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
at least one processor comprising program instructions stored in at least one memory that, upon execution by the processor, cause the IHS to:
generate an object model comprising a business object representing a business that provides one or more assets represented by one or more asset objects to a customer represented by a customer object of the business;
using a contract object of the object model, identify what level of services are to be provided by each asset for the customer; and
provide each of the services to the customer according to the identified level for the customer.

2. The IHS of claim 1, wherein the program instructions, upon execution by the host processor, further cause the IHS to generate the object model with partners represented by partner objects that provides services associated with the assets.

3. The IHS of claim 2, wherein the program instructions, upon execution by the host processor, further cause the IHS to use another contract model associated with the partner that is separate and distinct from the contract object associated with the business.

4. The IHS of claim 1, wherein the program instructions, upon execution by the host processor, further cause the IHS to use a virtual customer object to define an organizational structure of the customer.

5. The IHS of claim 4, wherein the program instructions, upon execution by the host processor, further cause the IHS to define the virtual customer object as a tenant boundary that comprises the visibility of objects and access control within a customer hierarchy of the customer.

6. The IHS of claim 1, wherein the program instructions, upon execution by the host processor, further cause the IHS to arrange the customer in a plurality of objects in a hierarchy comprising multiple groups of people that consume the assets, wherein the customer comprises a company.

7. The IHS of claim 1, wherein the program instructions, upon execution by the host processor, further cause the IHS to generate the object model with at least one organizational profile object that is linked to a plurality of personal profile objects that each stores personal information about each user in the company.

8. The IHS of claim 7, wherein the program instructions, upon execution by the host processor, further cause the IHS to generate the object model with at least one email object associated with a domain of the company.

9. The IHS of claim 1, wherein the assets comprise at least one of a computing hardware device and a cloud computing service.

10. An access control and delegation method comprising:
generating an object model comprising a business object representing a business that provides one or more assets represented by one or more asset objects to a customer represented by a customer object of the business;
using a contract object of the object model, identifying what level of services are to be provided by each asset for the customer; and
providing each of the services to the customer according to the identified level for the customer.

11. The access control and delegation method of claim 10, further comprising generating the object model with partners represented by partner objects that provides services associated with the assets.

12. The access control and delegation method of claim 11, further comprising using another contract model associated with the partner that is separate and distinct from the contract object associated with the business.

13. The access control and delegation method of claim 10, further comprising using a virtual customer object to define an organizational structure of the customer.

14. The access control and delegation method of claim 13, further comprising defining the virtual customer object as a tenant boundary that comprises the visibility of objects and access control within a customer hierarchy of the customer.

15. The access control and delegation method of claim 10, further comprising arranging the customer in a plurality of objects in a hierarchy comprising multiple groups of people that consume the assets, wherein the customer comprises a company.

16. The access control and delegation method of claim 10, further comprising generating the object model with at least one organizational profile object that is linked to a plurality of personal profile objects that each stores personal information about each user in the company.

17. The access control and delegation method of claim 16, further comprising generating the object model with at least one email object associated with a domain of the company.

18. A non-transitory memory storage device having program instructions stored thereon that, upon execution by an Information Handling System (IHS), cause the IHS to:
generate an object model comprising a business object representing a business that provides one or more assets represented by one or more asset objects to a customer represented by a customer object of the business;
using a contract object of the object model, identify what level of services are to be provided by each asset for the customer; and
provide each of the services to the customer according to the identified level for the customer.

19. The non-transitory memory storage device of claim 18, wherein the program instructions, upon execution by the host processor, further cause the IHS to generate the object model with partners represented by partner objects that provides services associated with the assets, and use another contract model associated with the partner that is separate and distinct from the contract object associated with the business.

20. The non-transitory memory storage device of claim 18, wherein the program instructions, upon execution by the host processor, further configured to use the IHS to use a virtual customer object to define an organizational structure of the customer, and define the virtual customer object as a tenant boundary that comprises the visibility of objects and access control within a customer hierarchy of the customer.
